(19) United States
(12) Patent Application Publication
(10) Pub. No.: US 2006/0050369 A1
(43) Pub. Date: Mar. 9, 2006

(54) Pulse width reduction for laser amplifiers and oscillators

(76) Inventors: James D. Kafka, Palo Alto, CA (US); David E. Spence, Mountain View, CA (US); Jianping Zhou, Palo Alto, CA (US); Ching-Yuan Chien, Palo Alto, CA (US); Juerg Aus der Au, St. Gallen, CA (US); Anton Krumm, Hohenems (AT)

Correspondence Address: NEWPORT CORPORATION, 1791 DEERE AVENUE, IRVINE, CA, 92606, US

(21) Appl. No.: 11/128,614

(22) Filed: May 14, 2005

Related U.S. Application Data
(60) Provisional application No. 60/570,992, filed on May 14, 2004.

(51) Int. Cl. H01S 3/00

(52) U.S. Cl. 359/348

(57) ABSTRACT

A pulse width reduction apparatus for an optical system is disclosed and includes at least one birefringent optical element configured to selectively adjust a spectral modulation depth of an optical signal while leaving a spectral transmission function of the optical signal substantially constant

### CROSS-REFERENCE TO RELATED APPLICATIONS

The present application claims priority to U.S. Provisional Patent Application Ser. No. 60/570,992, filed May 14, 2004, the contents of which are incorporated by reference in its entirety herein.

### BACKGROUND

In recent years, the applications for ultra-short pulse or sub-picosecond pulse laser systems have increased enormously. For example, these devices have been used in material processing and precision machining applications. In addition, research has shown these systems may be useful in biomedical applications for tissue ablation and treatment. More recently, these systems have been used in two-photon microscopy systems, and for all-optical histology applications.

For low power applications, these ultra-short pulse systems include at least an oscillator. In contrast, applications that require higher energy per pulse may utilize an oscillator and a regenerative amplifier. For example, ultra-short pulse or sub-picosecond pulse laser systems may include a chirped pulse amplifier (CPA). More specifically, in a CPA system, the short-pulses from the laser oscillator, often called the seed, are amplified using a regenerative amplifier, which is also optically pumped by yet another laser, often called the pump. Often the pulses from the seed laser are first temporally stretched so that the high peak powers that are present after amplification do not damage the components in the amplifier. Thereafter, the amplified pulses recites may be temporally compressed again. Presently, CPA systems which include a Ti:sapphire regenerative amplifier are capable of outputting laser pulses in the range of about 40 fs to about 100 fs at extremely high powers. However, a number of shortcomings of Ti:sapphire systems have been identified. For example, pump laser systems are required for use with Ti:sapphire regenerative amplifiers and are limited to argon lasers, frequency-doubled Nd:YAG, Nd:YLF, and Nd:YVO4 lasers. These lasers are typically large, complicated, inefficient and expensive.

In response thereto, a number of Ytterbium-doped ultra-short pulse laser systems have been developed. Unlike Ti:sapphire systems, Ytterbium-doped regenerative amplifiers may include diode laser pump devices. During use, these Ytterbium-doped systems may be configured to output laser pulses having pulse durations in the range of 400 fs to about 800 fs. While pulse durations of about 400 fs may be acceptable for some industrial applications, shorter pulse durations may be desired for a variety of alternate applications.

One factor shown to unfavorably increase pulse duration is referred to as gain narrowing. During use, the oscillator in an ultra-short pulse laser system is configured to output a seed pulse at a pre-determined center wavelength to the regenerative amplifier. The seed pulses have a finite bandwidth, which increases as the seed pulse duration decreases. However, the gain within the regenerative amplifier may not be constant as a function of wavelength. As such, a selective portion (e.g. central wavelengths of the input seed spectrum) may become more amplified than surrounding wavelengths or wavelengths at the edges of the input seed spectrum. As a result, the spectrum of the output pulse may be narrowed which may result in an increase in pulse duration. This effect is often referred to as spectral narrowing and can result in the seed pulses being temporally broadened in the amplifier.

In response thereto, several techniques have been developed to compensate for gain narrowing in ultra-short pulse laser systems. For example, the spectral characteristics of the seed pulse may be modified within the pulse stretcher prior to entering the regenerative amplifier. In one embodiment, a mask or similar device may be inserted between the oscillator and the regenerative amplifier and used to attenuate selective wavelengths of the seed pulse. FIG. 1 shows an exemplary wavelength distribution of a seed pulse from an oscillator prior to encountering the mask device. In contrast, FIG. 2 shows an exemplary wavelength distribution of the seed pulse after encountering the mask device. The maximum loss for the filter may be selected to substantially match the wavelength of maximum gain within the regenerative amplifier. Exemplary masks include multi-layer coated optics, metallic coated optics, birefringent filters, etalons, liquid-crystal spatial light modulators, and other devices. While having been proven useful in the past, a number of shortcomings have been identified. For example, for etalons and birefringent filters, the amount of attenuation (hereinafter referred to as spectral modulation depth) is fixed. As such, multiple etalons and birefringent filters must be substituted to adjust and fine-tune the attenuation of a system, thereby increasing manufacturing costs. Further, adjusting spectral modulation depth of the system while maintaining the wavelength distribution (hereinafter referred to as spectral transmission function) has proven difficult. Lastly, the cost and complexity of liquid-crystal spatial light modulators makes their widespread use cost prohibitive.

In light of the foregoing, there is an ongoing need for a pulse width reduction device configured to permit the selective adjustment of the spectral modulation depth of an optical signal while leaving a spectral transmission function of the optical signal substantially constant.

### SUMMARY

Various embodiments of pulse width reduction devices are disclosed herein. In one embodiment, a pulse width reduction apparatus for an optical system is disclosed and includes at least one birefringent optical element configured to selectively adjust a spectral modulation depth of an optical signal while leaving a spectral transmission function of the optical signal substantially constant.

In another embodiment, the present application is directed to a pulse width reduction apparatus for an optical system and recites at least one variable reflectivity etalon having a first region having a first reflectivity and at least a second region having at least a second reflectivity and configured to selectively adjust a spectral modulation depth of an optical signal while leaving a spectral transmission function substantially constant.

In yet another embodiment, the present application is directed to a laser system and includes at least one oscillator, at least one pulse stretcher in optical communication with the oscillator and configured to broaden a temporal duration of at least one optical signal incident thereon, at least one regenerative amplifier in optical communication with the pulse stretcher and configured to amplify the optical signal, at least one compressor in optical communication with the regenerative amplifier and configured to compress the optical signal, and at least one birefringent optical element configured to selectively adjust a spectral modulation depth of the optical signal while leaving a spectral transmission function substantially constant. For example, using a birefringent optical element made from vanadate and having a thickness of about 350 μm, the pulse duration from a Yb:KGW regenerative amplifier can be reduced from about 550 fs to about 420 fs.

In another embodiment, the present application is directed to a method of reducing the pulse width of an optical signal and includes positioning at least one variable reflectivity etalon having at least a first region having at least a first reflectivity and at least a second region having at least a second region having at least a second reflectivity within a beam path of the optical signal, translating the variable reflectivity etalon relative to the optical signal such that the optical signal is incident on locations of variable reflectivity on the etalon, and varying a spectral modulation depth of the signal while a spectral transmission function remains substantially constant.

In addition, the present application discloses a method of decreasing a pulse duration of an optical signal, comprising increasing a bandwidth of the optical signal from a gain medium by irradiating at least one optical crystal having one or more input polarizations along multiple principal axes.

Other features and advantages of the embodiments of pulse width reduction devices as disclosed herein will become apparent from a consideration of the following detailed description.

### BRIEF DESCRIPTION OF THE DRAWINGS

Various pulse width reduction devices will be explained in more detail by way of the accompanying drawings, wherein:

FIG. 1 shows an exemplary wavelength distribution of a seed pulse from an oscillator prior to encountering the mask device;

FIG. 2 shows an exemplary wavelength distribution of the seed pulse after encountering the mask device;

FIG. 3 shows a block diagram of an embodiment of a laser system having an embodiment of a pulse width reduction device included therein;

FIG. 4 shows an embodiment of a pulse width reduction apparatus positioned within an oscillator;

FIG. 5 shows a perspective view of an embodiment of a pulse width reduction apparatus;

FIG. 6 shows a graph of the spectral transmission of an embodiment of a pulse width reduction apparatus;

FIG. 7 shows a perspective view of an alternate embodiment of a pulse width reduction apparatus;

FIG. 8 shows another embodiment of a pulse width reduction apparatus using multiple birefringent gain crystals to decrease the pulse width of an optical signal; and

FIG. 9 shows a graphical representation of the sum of two emission spectra broadened using birefringent gain crystals shown in FIG. 8; and

FIG. 10 shows another embodiment of a pulse width reduction apparatus using a single birefringent gain crystal to decrease the pulse width of an optical signal.

### DETAILED DESCRIPTION

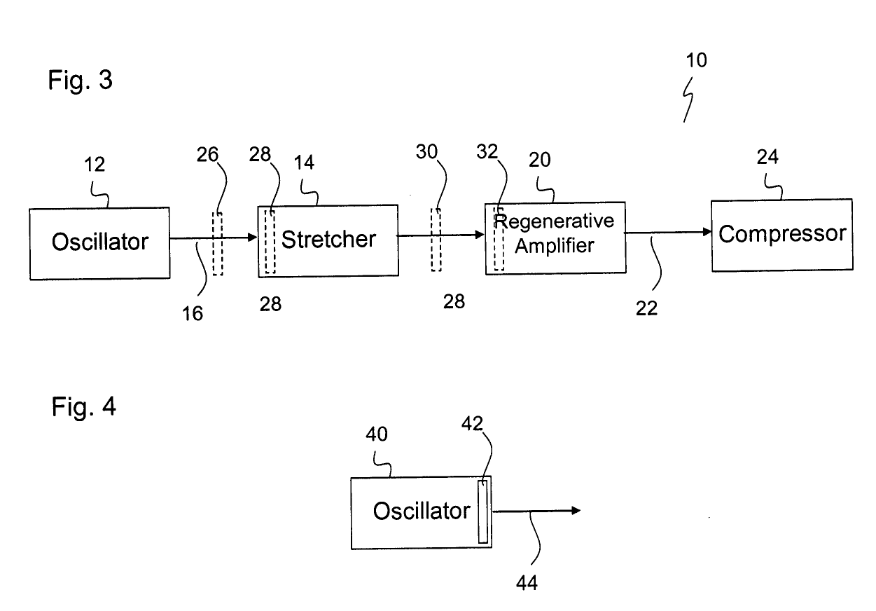

FIG. 3 shows a block diagram of an embodiment of a laser system having at least one pulse width reduction device included therein. As shown, the laser system 10 may include at least one oscillator 12 in optical communication with at least one pulse stretcher 14. In one embodiment, the oscillator 12 includes one or more diode laser pump sources. In an alternate embodiment, the oscillator 12 may comprise one or more Ti:Al2O3, Nd:YVO4, Nd:glass, Yb:tungstate, Yb:glass, Yb:YAG, fiber lasers, or semiconductor lasers. In short, any variety of optical oscillators may be used. A shown, the oscillator 12 emits at least one optical signal 16 having a wavelength range from about 700 nm to about 1600 nm to the pulse stretcher 14. The pulse stretcher 14 may be configured to broaden the temporal duration of an optical signal 16 emitted by the oscillator 12. In one embodiment, the pulse stretcher comprises a grating pair. Those skilled in the art will appreciate that any variety of pulse stretchers may be used with the present system, including, without limitation, chirped mirrors, prism pairs, bulk (chirped) Bragg reflectors, optical fibers, or other bulk dispersive materials.

Referring again to FIG. 3, at least one regenerative amplifier 20 receives a temporally-broadened optical signal 18 from the pulse stretcher 14 and amplifies the optical signal across a range of wavelengths. In one embodiment, the regenerative amplifier 20 comprises an Ytterbium-doped amplifier. In another embodiment, regenerative amplifier 20 comprises a Ti:sapphire amplifier. Those skilled in the art will appreciate that any type of regenerative amplifier 20 may be used herein. The amplified optical signal 22 may be extracted from the amplifier 20 and directed to at least one pulse compressor 24. The pulse compressor 24 is configured to narrow the temporal duration of the amplified signal 22 and emit an ultra-short pulse from the laser system 10. Exemplary pulse compression systems include, without limitation, chirped mirrors, prism pairs, bulk (chirped) Bragg reflectors, optical fibers, or other bulk dispersive materials. Optionally, any variety of additional optical elements may be used within the laser system 10 including, without limitation, mirrors, lenses, optical components, fiber couplers, and the like.

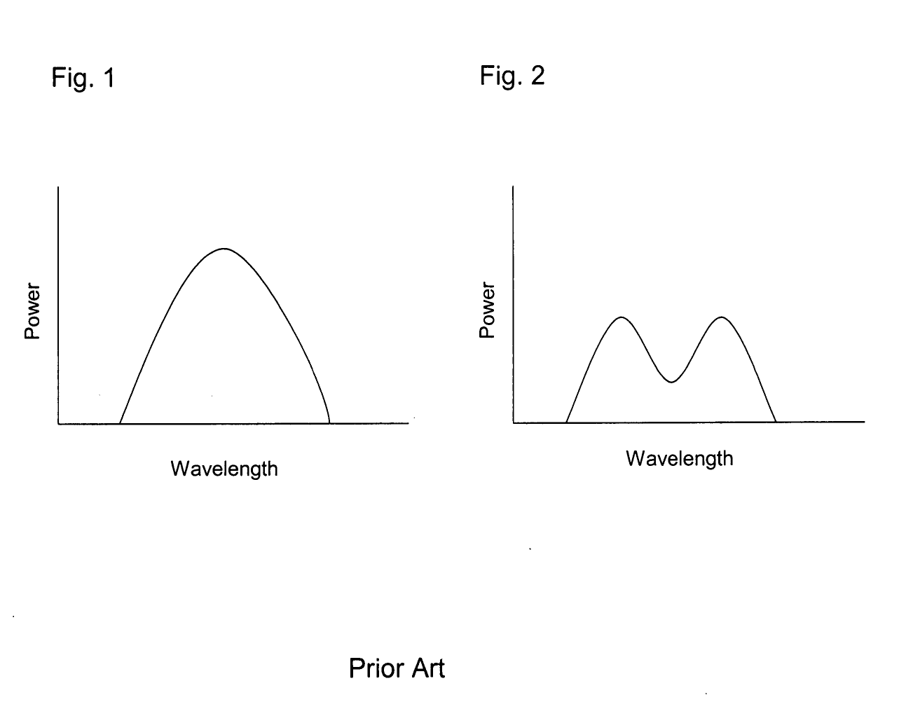

As shown in FIG. 3, at least one pulse width reduction apparatus may be positioned within the laser system 10. As shown in FIG. 3, in one embodiment the pulse width reduction apparatus 26 may be positioned between the oscillator 12 and the pulse stretcher 14 and configured to selectively adjust the spectral modulation depth of the output signal 16 while spectral transmission function thereof remains substantially constant. (see FIG. 1). In another embodiment, a pulse width reduction apparatus 28 may be positioned within the pulse stretcher 14. Optionally, a pulse width reduction apparatus 30 may be positioned between the pulse stretcher 14 and the regenerative amplifier 20. Further, a pulse width reduction apparatus 32 may be included within the regenerative amplifier 20. In short, any number of pulse width reduction devices may be included within the laser system 10 and may be located at various locations therein. As such, the pulse width reduction apparatus 26 may be positioned intracavity or extracavity.

Optionally, at least one pulse width reduction apparatus may be positioned within at least one oscillator. FIG. 4 shows an oscillator 40 having at least one pulse width reduction apparatus 42 located therein. As a result, the oscillator 40 emits an output signal 44 having a modified spectrum. Those skilled in the art will appreciate that the oscillator 40 disclosed herein may be incorporated in any variety of existing laser systems. Like the oscillators disclosed above, the oscillator 40 may comprise one or more diode laser pump sources, one or more Ti:Al₂O₃, Nd:YVO₄, Nd:glass, Yb:tungstate, Yb:glass, Yb:YAG, fiber lasers, semiconductor lasers, and the like. In short, any variety of optical oscillator may be used.

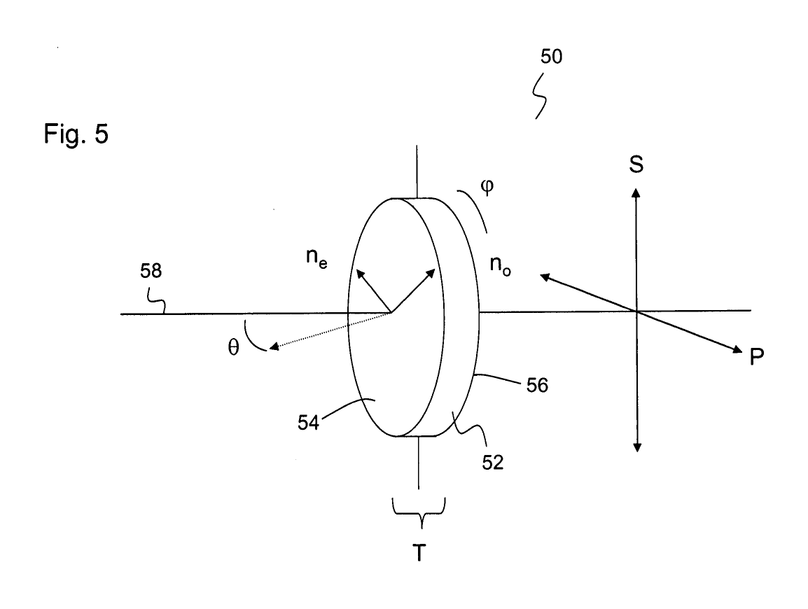

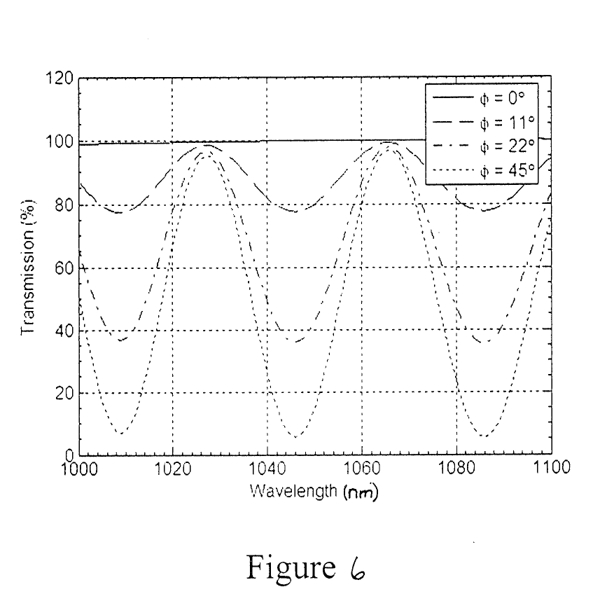

FIG. 5 shows an embodiment of a pulse width reduction apparatus. As shown, the pulse width reduction apparatus 50 comprises a body 52 having a first surface 54 and at least a second surface 56. In one embodiment, the pulse width reduction apparatus 50 comprises a waveplate spectral filter. In this embodiment, the pulse width reduction apparatus 50 comprises one or more birefringent materials. Any variety of birefringent materials may be used to form the pulse width reduction apparatus 50. For example, in one embodiment the pulse width reduction apparatus 50 is manufactured from quartz having a thickness of about 0.1 mm to about 30 mm. Optionally, the pulse width reduction apparatus 50 may be manufactured from alternate materials, including, without limitation, vanadate, α-BBO, calcite, KBBF, KGW, KYW and the like. In another embodiment, a thin plate of one or more birefringent materials may be laminated or otherwise coupled to form a thicker device body. The thickness T of the body 52 is manufactured both to provide approximately a half wave of retardation at a wavelength corresponding to the peak gain of the regenerative amplifier 20, and an appropriate spectral bandwidth such that the maximum attenuation will occur at the peak gain wavelength while leaving the wavelength at the wings of the gain spectrum substantially unaffected. Optionally, one or more coatings may be applied to either the first surface 54, the second surface 56, or both. Exemplary coatings include, without limitation, anti-reflective coatings, narrow bandpass coatings, and the like.

As shown in FIG. 5, the pulse width reduction apparatus 50 may be positioned substantially normal to the optical axis 58 along which a laser pulse is propagating. The pulse width reduction apparatus 50 may be tilted an angle θ relative to the optical axis 58, thereby permitting the user to optimize the wavelength at which the maximum attenuation will occur. Unlike prior art birefringent devices which were positioned at Brewster's angle, the pulse width reduction apparatus may be tilted from approximately 0 degrees to about 25 degrees from the optical axis 58.

During use, the pulse width reduction apparatus 50 may be rotated a desired rotation angle φ about the optical axis 58. As a result, the spectral modulation depth of pulse width reduction apparatus 50 may be selectively controlled by a user. Unlike prior art systems, the pulse width reduction apparatus 50 permits the user to controllably adjust the spectral modulation depth while leaving the spectral transmission function substantially constant. More succinctly stated, the user may adjust the attenuation of the device without shifting or tuning wavelength transmission therethrough. The spectral modulation depth may be adjusted from about 0% to about 100%, in contrast to the limited adjustability of prior art systems. As a result, the user may easily adjust the spectral modulation depth with a single pulse width reduction device 50 and optimize the transmission spectrum for varying gain levels which may be encountered in the amplifier as the repetition rate and pump levels to the amplifier are varied.

FIG. 6 shows a graph of the spectral transmission of an embodiment of a pulse width reduction apparatus. As shown, the attenuation of the device is increased as the rotation angle φ is increased. More specifically, the transmission at approximately 1042 nm through the pulse width reduction apparatus positioned at approximately normal incidence to a signal beam and having a rotation angle φ of about 0 degrees is approximately 100%. The transmission of the same wavelength through the pulse width reduction apparatus rotated to a rotation angle φ of about 11 degrees is approximately 78%. An increase in the rotation angle φ0 to about 22 degrees results in a decrease in the transmission of 1042 nm to about 38%. Further rotation of the pulse width reduction apparatus to a rotation angle φ of about 45 degrees results in a decrease in the transmission of the 1042 nm to about 10%. Those skilled in the art will appreciate that the attenuation occurred only for selected wavelengths.

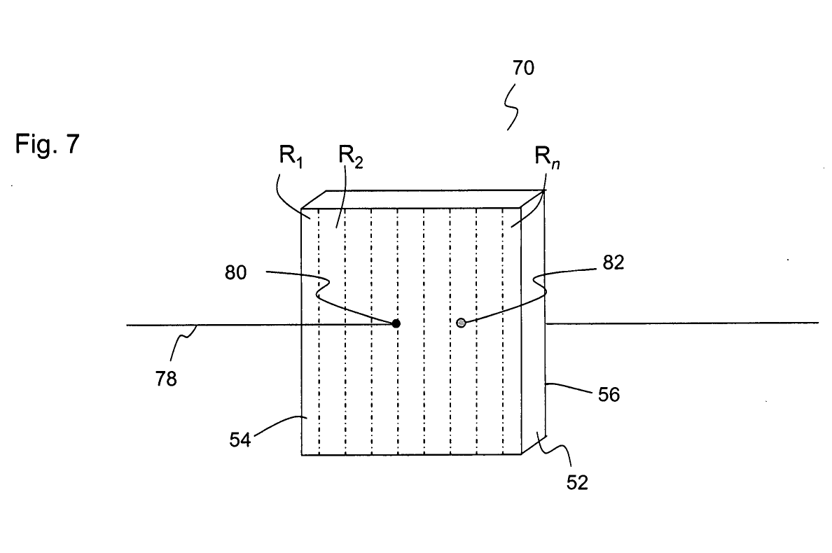

FIG. 7 shows an alternate embodiment of a pulse width reduction apparatus. As shown, the pulse width reduction apparatus 70 may include a device body 72 having a first surface 74 and at least a second surface 76, In one embodiment, the device body 72 comprises an etalon. The device body 72 may be manufactured from any variety of materials. For example, in one embodiment the device body 72 is manufactured from semiconductor materials, glass, nitrocellulose, mylar, thin film materials, hydrogels, and the like. The thickness T of the device body 72 is manufactured both to provide approximately destructive interference at a wavelength corresponding to the peak gain of the regenerative amplifier 20, and an appropriate spectral bandwidth such that the maximum attenuation will occur at the peak gain wavelength while leaving the wavelength at the wings of the gain spectrum substantially unaffected. Those skilled in the art will appreciate that the thickness of the material will depend on the refractive index of the material chosen and can vary from about 0.01 mm to about 30 mm.

Further, at least one coating may be selectively applied to the first surface 74, the second surface 76, or both. The coatings applied to the first and/or second surfaces 74, 76 may form a variable reflectivity pulse width reduction apparatus. As shown in FIG. 7, a first region R₁ having a first reflectivity and at least a second region R₂ having a second reflectivity may be formed on the device body 72. Any number of reflective regions Rn may be formed on the device body 72. As shown in FIG. 7, multiple distinct reflective regions may be formed on the device body 72 thereby forming a variable reflectivity device. In the alternative, the multiple reflective regions may form a continuously variable reflectivity device. Any variety of coating may be applied to the device body 72. Exemplary coating include, without limitation, gold, silver, aluminum, dielectric layers, and the like.

During use, the pulse width reduction apparatus 70 is inserted into the propagation path of a signal beam. Like the previous embodiment, the pulse width reduction apparatus 70 of the present embodiment may be positioned substantially normal to the optical axis 78 of the propagating signal. As shown, the signal beam propagating along the optical axis 78 is incident on the pulse width reduction apparatus 70 at point 80. In one embodiment, the user may vary the spectral modulation depth by moving the pulse width reduction apparatus 70 relative to the optical axis such that the signal beam is incident on the device body 72 at point 82. As a result, the spectral modulation depth of the pulse width reduction apparatus 70 will be varied as the device body 72 is translated relative to the beam. As such, the spectral modulation depth of pulse width reduction apparatus 70 may be selectively controlled by a user. The spectral modulation depth may be adjusted from about 0% to about 100%, in contrast to the limited adjustability of prior art systems. In an alternate embodiment, the signal beam may be moved while the device body 72 is held fixed.

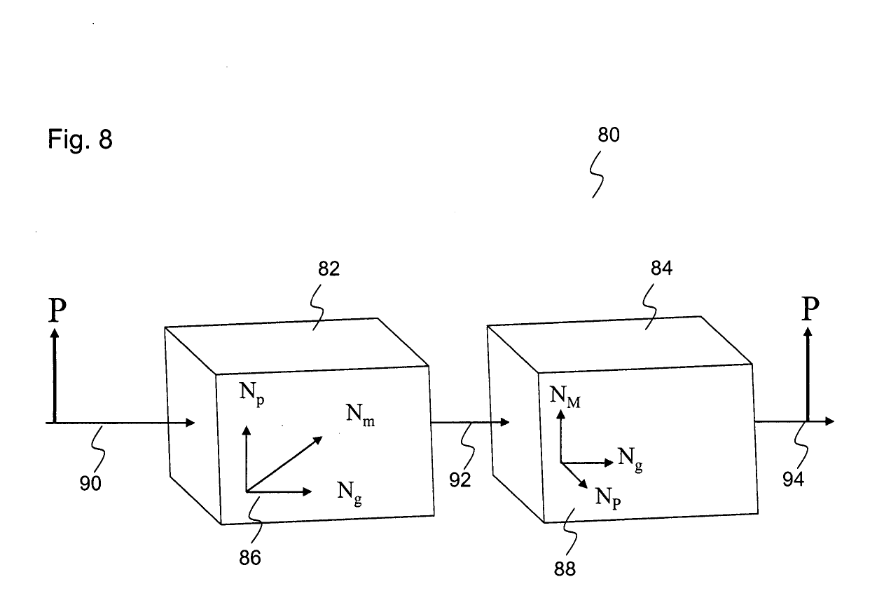

FIGS. 8-10 show alternate embodiments of pulse width reduction devices. As shown in FIG. 8, the pulse width reduction apparatus 80 may include a first birefringent gain crystal 82 and at least a second birefringent gain crystal 84. In the illustrated embodiment, the first birefringent gain crystal 82 has a first polarization characteristic 86. Similarly, the second birefringent gain crystal 84 has a second polarization characteristic 88. In one embodiment, the second polarization characteristic 88 may be orthogonal to the first polarization characteristic. During use, a vertically polarized input signal 90 may be amplified or may have the temporal duration broadened as a Np polarized signal in the first birefringent gain crystal 82. Thereafter, the amplified signal 92 may be amplified or may have the temporal duration broadened as a Nm signal in the second birefringent gain crystal 84. When combined, the output signal 94 comprised of the sum of the two emission spectra provides a much broader spectra bandwidth compared to the bandwidth that would have been obtained if either crystal had been used alone. In this manner the gain bandwidth of the amplifier can be increased. Further, this configuration permits pumping with fiber coupled diode sources that produce unpolarized light as described in U.S. Pat. No. 6,891,876, filed on Aug. 30, 2002, the entire contents of which are hereby incorporated by reference in its entirety.

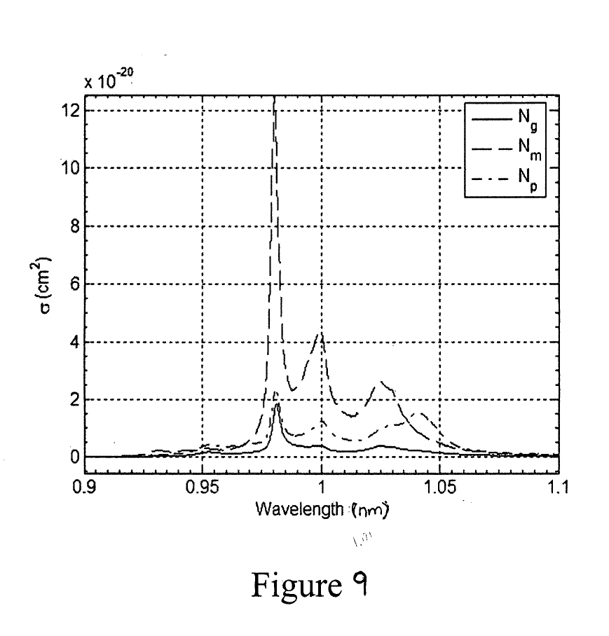

Exemplary birefringent gain crystals for use with this system include, without limitation Yb:KGW, Yb:KYW, Yb:KLuW, and the like. In one embodiment that uses the birefringent gain crystal Yb:KGW the emission spectrum for two different output polarizations may be shifted. For example, in one embodiment, the emission spectrum was shifted by about 5 nm. Further, when the input signal 90 is propagated in the Ng direction, the pulses with the polarization in either the Nm or the Np directions may be amplified. As shown in FIG. 9, the sum of the two emission spectra may be much broader than either one emission spectra alone. In one embodiment, the two crystals are positioned within an amplifier. In another embodiment, the two crystals are positioned within an oscillator. Optionally, one crystal may be positioned within the oscillator and another crystal may be positioned within the amplifier.

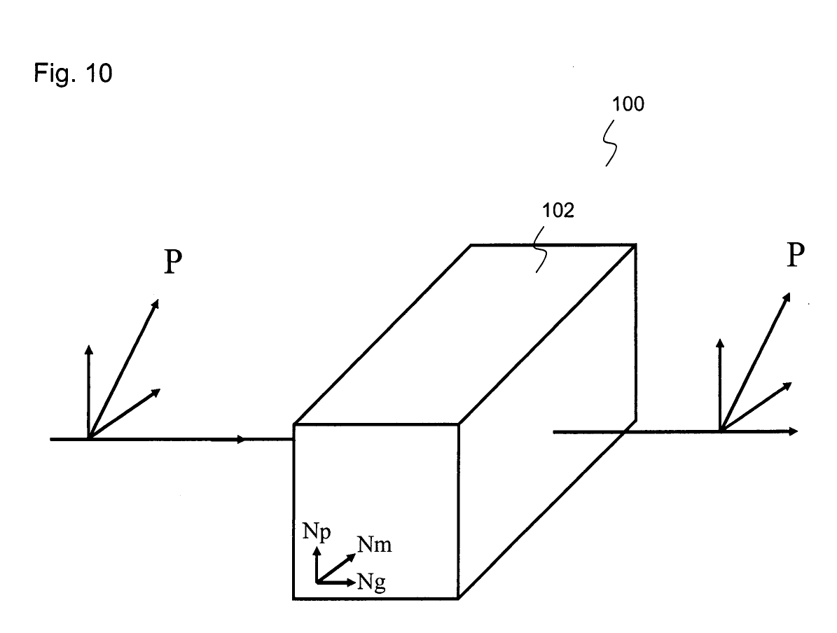

FIG. 10 shows an alternate embodiment of a pulse width reduction device. As shown, the pulse width reduction device 100 includes a single birefringent gain crystal 102 positioned within an amplifier or an oscillator. The single birefringent gain crystal 102 is configured with the incident polarization set at 45 degrees. As such, the gain is accessed in both the Nm and Np directions simultaneously. Different orientations for the crystal, including polarization along the a, b and c axes can be used as well.

Embodiments disclosed herein are illustrative of the principles of the invention. Other modifications may be employed which are within the scope of the invention. Accordingly, the devices disclosed in the present application are not limited to that precisely as shown and described herein.

What is claimed is:

1. A pulse width reduction apparatus for an optical system, comprising at least one birefringent optical element configured to selectively adjust a spectral modulation depth of an optical signal while leaving a spectral transmission function of the optical signal substantially constant.

2. The device of claim 1 wherein the optical system comprises a laser amplifier.

3. The device of claim 1 wherein the optical system comprises a laser oscillator.

4. The device of claim 1 wherein the optical system comprises at least one optical system selected from the group consisting of Yb doped amplifiers, Ti:sapphire amplifiers, Nd doped amplifiers, semiconductor amplifiers, and chirped pulse amplifiers.

5. The device of claim 1 wherein the birefringent optical element is positioned within a laser cavity.

6. The device of claim 1 wherein the birefringent optical element is positioned outside a laser cavity.

7. The device of claim 1 wherein the birefringent optical element is positioned within an oscillator positioned within the optical system.

8. The device of claim 1 wherein the birefringent optical element is positioned between an oscillator and a pulse stretcher positioned within the optical system.

9. The device of claim 1 wherein the birefringent optical element is positioned within a pulse stretcher positioned within the optical system.

10. The device of claim 1 wherein the birefringent optical element is positioned between a pulse stretcher and a regenerative amplifier positioned within the optical system.

11. The device of claim 1 wherein the birefringent optical element is positioned within a regenerative amplifier positioned within the optical system.

12. The device of claim 1 wherein the birefringent optical element is manufactured from at least one material selected from the group consisting of quartz, vanadate, α-BBO, calcite, KBBF, KGW, and KYW.

13. The device of claim 1 wherein the optical signal comprises a seed pulse.

14. The device of claim 1 wherein the birefringent optical element is positioned substantially perpendicular to an optical axis of the incident beam.

15. A pulse width reduction apparatus for an optical system, comprising at least one variable reflectivity etalon having at least a first region having at least a first reflectivity and at least a second region having at least a second reflectivity and configured to selectively adjust a spectral modulation depth of an optical signal while leaving a spectral transmission function substantially constant.

16. The device of claim 15 wherein the optical system comprises a laser amplifier.

17. The device of claim 15 wherein the optical system comprises a laser oscillator.

18. The device of claim 15 wherein the optical system comprises at least one optical system selected from the group consisting of Yb doped amplifiers, Ti:sapphire amplifiers, Nd doped amplifiers, semiconductor amplifiers, and chirped pulse amplifiers.

19. The device of claim 15 wherein the variable reflectivity etalon is positioned within a laser cavity.

20. The device of claim 15 wherein the variable reflectivity etalon is positioned outside a laser cavity.

21. The device of claim 15 wherein the variable reflectivity etalon is positioned within an oscillator positioned within the optical system.

22. The device of claim 15 wherein the variable reflectivity etalon is positioned between an oscillator and a pulse stretcher positioned within the optical system.

23. The device of claim 15 wherein the variable reflectivity etalon is positioned within a pulse stretcher positioned within the optical system.

24. The device of claim 15 wherein the variable reflectivity etalon is positioned between a pulse stretcher and a regenerative amplifier positioned within the optical system.

25. The device of claim 15 wherein the variable reflectivity etalon is positioned within a regenerative amplifier positioned within the optical system.

26. The device of claim 15 wherein the optical signal comprises a seed pulse.

27. A laser system, comprising:
at least one oscillator;
at least one pulse stretcher in optical communication with the oscillator and configured to broaden a temporal duration of at least one optical signal incident thereon;
at least one regenerative amplifier in optical communication with the pulse stretcher and configured to amplify the optical signal;
at least one compressor in optical communication with the regenerative amplifier and configured to compress the optical signal; and
at least one birefringent optical element configured to selectively adjust a spectral modulation depth of the optical signal while leaving a spectral transmission function substantially constant.

28. The device of claim 27 wherein the regenerative amplifier is selected from a group consisting of Yb doped amplifiers, Ti:sapphire amplifiers, Nd doped amplifiers, semiconductor amplifiers, and chirped pulse amplifiers.

29. A method of reducing the pulse width of an optical signal, comprising:
positioning at least one birefringent optical element within a beam path of the optical signal;
rotating the birefringent optical element about the beam path; and
varying a spectral modulation depth of the signal while a spectral transmission function remains substantially constant.

30. A method of reducing the pulse width of an optical signal, comprising:
positioning at least one variable reflectivity etalon having at least a first region having at least a first reflectivity and at least a second region having at least a second reflectivity within a beam path of the optical signal;
translating the variable reflectivity etalon relative to the optical signal such that the optical signal is incident on locations of variable reflectivity formed on the etalon; and
varying a spectral modulation depth of the signal while a spectral transmission function remains substantially constant.

31. A method of decreasing a pulse duration of an optical signal, comprising increasing a bandwidth of the optical signal from a gain medium by irradiating at least one optical crystal having input polarizations along more than one of the principal axes.

32. The method of claim 31 wherein at least one of the principal axes is a crystalo-optic axes.

33. The method of claim 31 wherein at least one of the principal axes is a crystalographic axes.

34. The method of claim 31 further comprising providing a gain medium selected from the group consisting of Yb doped material, and Nd doped materials.
